(19) United States
(12) Patent Application Publication
(10) Pub. No.: US 2026/0053310 A1
(43) Pub. Date: Feb. 26, 2026

(54) VACUUM FILTER BAG WITH SILVER-IMPREGNATED LAYER FOR ANTIMICROBIAL ACTION

(71) Applicants: Edmond F. DiRenna, Littleton, CO (US); Barry R. Schwartz, Las Vegas, NV (US)

(72) Inventors: Edmond F. DiRenna, Littleton, CO (US); Barry R. Schwartz, Las Vegas, NV (US)

(21) Appl. No.: 19/371,525

(22) Filed: Oct. 28, 2025

Related U.S. Application Data
(63) Continuation of application No. 18/419,513, filed on Jan. 22, 2024.
(63) Continuation of application No. 17/942,151, filed on Sep. 11, 2022, now abandoned.
(63) Continuation of application No. 16/269,518, filed on Feb. 6, 2019, now abandoned.
(60) Provisional application No. 62/710,054, filed on Feb. 6, 2018.

(51) Int. Cl. A47L 9/14; B01D 39/16; B01D 46/00; B01D 46/02; B01D 46/62

(52) U.S. Cl. CPC A47L 9/14; A47L 9/1427; B01D 39/1623; B01D 46/0005; B01D 46/0028; B01D 46/02; B01D 46/62; B01D 2239/0442; B01D 2239/0492; B01D 2239/0618; B01D 2239/065; B01D 2279/55

(57) ABSTRACT

A filter bag configured for use in a vacuum cleaner is provided. The filter bag includes a first layer of filter material with a selected value of efficiency in removing airborne particulates, and a second layer that is impregnated with silver or a silver compound with antimicrobial properties.

### CROSS-REFERENCES TO RELATED APPLICATIONS

This application is a continuation of application Ser. No. 18/419,513 filed on Jan. 22, 2024 titled “Vacuum Filter Bag With Silver-Impregnated Layer For Antimicrobial Action,” which is a continuation of application Ser. No. 17/942,151 filed on Sep. 11, 2022 titled “Vacuum Filter Bag With Silver-Impregnated Layer For Antimicrobial Action,” which is a continuation of Application Ser. No. 16/269,518 filed on Feb. 6, 2019 titled “Vacuum Filter Bag With Silver-Impregnated Layer For Antimicrobial Action,” which claims priority of provisional Application Ser. No. 62/710,054 Titled “Vacuum Filter Bag With Silver-Impregnated Layer For Antimicrobial Action” filed on Feb. 6, 2018, all of which are incorporated herein by reference in their entirety for all that is taught and disclosed therein, none of which are admitted to be prior art with respect to the present invention by its mention in this cross-reference section.

### BACKGROUND

### a. Field of the Invention

The present invention relates generally to air filters, and, more particularly, to high-efficiency filters, and filter materials that are used in the manufacture of air filters, including vacuum filter bags.

### b. Related Art

Air filters and filter media are commonly classified using the MERV (Minimum Efficiency Reporting Value) system. In this system, a filter is assigned a number between 1 and 20 according to its overall efficiency in removing particles from air-a higher number representing a more efficient filter. For example, for residential applications in the US, the ANSI/ASHRAE Standard 62.2-200716 requires a filter with a designated minimum efficiency of MERV 6 or better. A filter with a MERV rating of 6 is capable of removing 35-50% of airborne particles that are 3-10 um (micrometers) across. Most common home furnace filters are in the range of MERV 6-8. This is in contrast, for example, with a filter with a MERV rating of 13, which is capable of removing up to 75% of particles of 0.3 μm, and 90% of particles larger than 1 μm. A class of filter that is receiving increased interest, as concern with airborne contaminants grows, is referred to as HEPA (High Efficiency Particulate Air). A HEPA rating corresponds to a MERV 17, and indicates that the filter is capable of removing 99.97% of particles as small as 0.3 μm.

Because of the increased interest in more efficient filters, some manufacturers or sellers describe their filters as HEPA-type, HEPA-like, HEPA-style, etc. Such terms suggest that the products in question have not been tested by an independent laboratory, or were not found to meet the MERV 17 criteria. On the other hand, the difference in efficiency between a MERV 13 rating and a MERV 17 rating is, in practice, insignificant except in highly critical environments, such as laboratories, hospitals, clean rooms and the like. In a residence, the difference would be generally undetectable, because homes are not sealed from the surrounding environment, and air exchange with the exterior is frequent or continuous.

### SUMMARY OF THE INVENTION

According to an embodiment, a filter assembly is provided that includes a first element with a selected value of efficiency in removing airborne particulates, and a second element that is impregnated with silver or a silver compound.

According to an embodiment, the first element includes a plurality of layers, each having a respective value of efficiency in removing airborne particulates.

According to an embodiment, the second element also functions as one of the layers of the first element.

According to an embodiment, the filter assembly is configured such that air passes first through the first element, then through the second element.

According to another embodiment, the first element has a MERV rating of 13 or greater.

According to an embodiment, the functions of the first and second elements are combined into a single element that is configured to remove airborne particulates and that is impregnated with silver.

According to an embodiment, the filter assembly is a vacuum filter bag.

According to an embodiment, a vacuum cleaner is provided that is configured to receive the vacuum filter bag.

According to a further embodiment, the vacuum includes an output filter configured to filter air as it exits the vacuum cleaner.

According to an embodiment, the output filter has a MERV rating that is higher than that of the filter assembly.

According to an embodiment, the second filter includes a layer of silver-impregnated material.

### BRIEF DESCRIPTION OF THE DRAWINGS

FIG. 1 is a diagrammatic side elevation view of a vacuum cleaner, according to an embodiment.

FIG. 2A is a diagrammatical side view of a vacuum filter bag such as can be used in the vacuum cleaner of FIG. 1, according to an embodiment.

FIG. 2B is a detailed diagrammatic view of a portion, indicated at 2B in FIG. 2A, of the vacuum filter bag of FIG. 2A, according to an embodiment.

FIG. 3 is a perspective view of an air filter assembly 300, according to an embodiment, with one side removed to show internal elements.

FIG. 4 is a diagrammatic representation of a canister vacuum, according to an embodiment.

### DETAILED DESCRIPTION

It will be understood that the scope of the appended claims should not be limited by particular embodiments set forth herein, but should be construed in a manner consistent with the specification as a whole.

In the drawings, a reference number followed by a letter, e.g., “203a, 203b,” is used where it may be useful in the corresponding description to refer to or differentiate between specific ones of a number of otherwise similar or identical elements. Where the description omits the letter from a reference, and refers to such elements by number only, this can be understood as a general reference to the elements identified by that reference number, unless other distinguishing language is used.

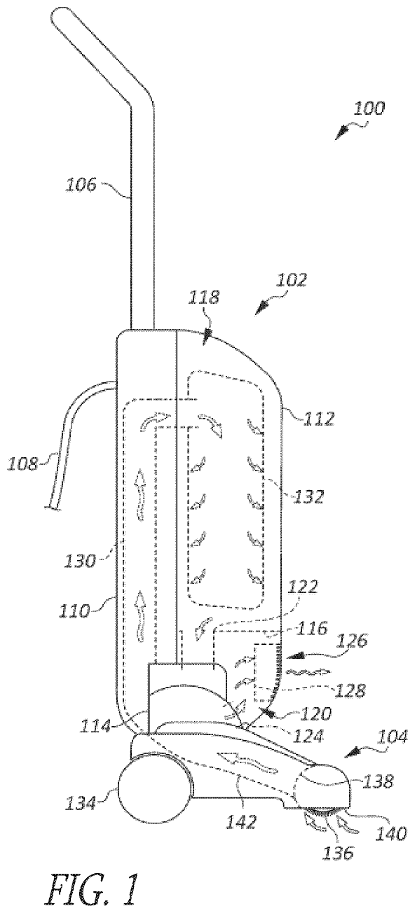

FIG. 1 is a diagrammatic side elevation view of a vacuum cleaner 100, according to an embodiment. The vacuum cleaner 100 includes a main body 102, a base assembly 104, a handle 106, and a power cord 108. Elements that are inside the vacuum cleaner 100 are shown in hidden lines.

The main body 102 includes a support element 110, a bag housing 112, and a motor assembly 114. The bag housing 112 defines a hollow interior that is separated by a dividing wall 116 into a bag chamber 118 and an output plenum 120. The motor assembly 114 includes a motor and an air blower (not shown in detail), with an air intake 122 in fluid communication with the bag chamber 118 and an exhaust outlet 124 in fluid communication with the output plenum 120. A plurality of louvres collectively form a clean air outlet 126 between the output plenum 120 and the exterior of the bag housing 112. A filter assembly 128 is positioned within the output plenum 120 over the clean air outlet 126 such that air passes through the filter assembly 128 prior to exiting the output plenum. A waste intake channel 130 is positioned within the support element 110 with an upper end extending into the bag chamber 118. A vacuum filter bag 132 is positioned within the bag chamber 118 and is attached to the upper end of the waste intake channel 130.

The base assembly 104 includes a pair of rear wheels 134 and a beater brush 136. The beater brush 136 is rotatably positioned within a collection chamber 138 and extends from a waste intake port 140 so as to make contact with the floor beneath the base assembly 104. An air passage 142 is in fluid communication with the collection chamber 138 and is coupled to the waste intake channel 130 via a flexible coupling (not shown in detail) that permits rotation of the main body 102 relative to the base assembly 104. The main body 102 is configured to rotate relative to the base assembly 104 around a rotation axis of the motor, which is coupled via a drive belt to the beater brush 136, which rotates during operation.

During operation, the air blower draws air into the motor assembly 114 from the bag chamber 118 via the air intake 122 and blows the air from the exhaust outlet 124 into the output plenum 120. This produces a partial vacuum within the bag chamber 118, drawing air into the vacuum filter bag 132 via the waste intake channel 130, the air passage 142, and the collection chamber 138, pulling air, together with waste matter lifted by the beater brush 136, from the exterior via the waste intake port 140. The waste is carried with the air into the vacuum filter bag 132, which filters the waste from the air and passes the air through permeable walls to the bag chamber 118.

As noted above, vacuum filter bags, like other air filters, are rated according to their efficiency in removing particulates from air as it passes. As filter efficiency increases, the energy required to transmit air increases. To mitigate the increased resistance, most high-efficiency air filters are provided with deep pleats. This increases the thickness of the filter, but also increases the available surface area, reducing air resistance. Additionally, in many systems, a more powerful blower motor is provided to move air through the filter. However, space within a vacuum cleaner is limited, and any increase in bag thickness reduces the capacity of the bag, and a more powerful motor would be larger, heavier, and more expensive, making the vacuum less attractive to consumers. Thus, most vacuum cleaners on the market are provided with vacuum filter bags that are not HEPA rated, and that have a relatively low MERV rating. As a result, many pathogens that are lifted from a floor or carpet by a vacuum cleaner pass through the vacuum filter bag and are distributed into the air, to settle onto other surfaces in the room, or to be ingested by room occupants.

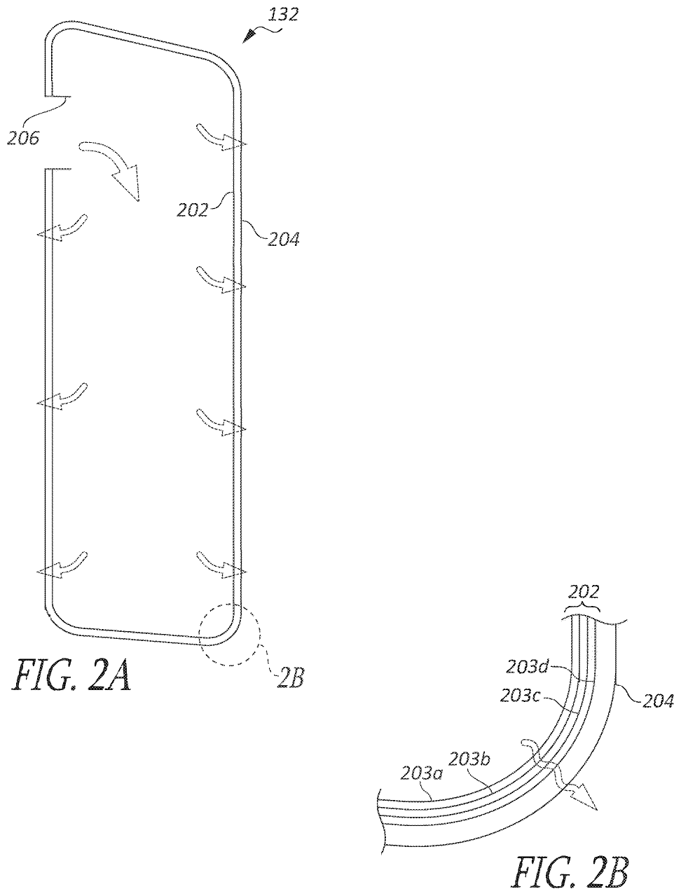

FIG. 2A is a diagrammatical side view of a vacuum filter bag 132 such as can be used in the vacuum cleaner 100 of FIG. 1, according to an embodiment. FIG. 2B is a detailed diagrammatic view of a portion of the vacuum filter bag 132 indicated at 2B in FIG. 2A, according to an embodiment. The vacuum filter bag 132 includes an inner bag wall 202, an outer bag wall 204, and a vacuum engagement element 206. The inner bag wall 202 can be made of any appropriate material with a MERV rating that is adequate for the intended use. For example, the inner bag wall 202 can be a melt-blown non-woven filter material, a spun fiberglass material, a woven fabric material, etc. Preferably, the MERV rating is 9 or higher, and according to an embodiment, the MERV rating is at least 13, which is sufficient to remove many pathogens and contaminants from the air. According to another embodiment, the inner bag wall 202 is a true HEPA filter, (MERV 17), which is sufficient to remove substantially all bacteria, as well as mold and fungus spores and many viruses.

The vacuum engagement element 206 is configured to engage a mating structure of a selected make and model of vacuum cleaner. Such engagement elements can include various combinations of seals, rigid panels, and openings, etc. Most vacuum cleaner machines require engagement elements and bag designs that are unique to the particular make and model. The claims are not limited to any particular filter bag design except where such limitation is explicit in the claim.

According to an embodiment, as shown in FIG. 2B, the inner bag wall 202 includes a plurality of individual layers 203, each having a respective degree of efficiency, and each contributing to a collective efficiency. For example, according to an embodiment, an innermost layer 203a is of a porous tissue material configured to capture a first level of pet hair, dust, fluff, etc. A second layer 203b, and even a third layer 203c can be of the same porous tissue material, while a finer and heavier outermost layer 203d is of either a sufficiently porous paper or a pressed fiber material that serves to filter out the remaining finer particles. Alternatively, each of the layers 203 of the inner bag wall 202 is of a progressively finer filter material, each configured to capture more and smaller particles. In either case, the overall or collective efficiency of the inner bag wall 202 is typically greater than the efficiency of any one of the individual layers, such that while the outermost-and finest-layer 203d may have a MERV rating of no more than 9, the collective efficiency may be MERV 13 or higher.

The outer bag wall 204 can also be made, for example, of a melt-blown non-woven filter material, porous paper, or any other appropriate material. In the embodiment shown, the outer bag wall 204 has a MERV rating that is at least slightly lower than that of the inner bag wall 202, so as to permit air to pass without significantly increasing the total air flow resistance of the vacuum filter bag 132. The material of the outer bag wall 204 is impregnated with silver, or a compound that includes silver, which acts as an antimicrobial agent, preventing live pathogens from passing through the inner and outer bag walls.

As used herein, the term impregnated means to have been subject to any process or treatment by which silver, ions of silver, or silver-bearing compounds are incorporated into, on, or with a porous or permeable material so as to come into contact with air and/or air-entrained pathogens as the air passes through the material. Processes that can be employed include infusion, spraying, sintering, sputter or vapor deposition, plating, etc.

According to an embodiment, micro-and/or nanoparticles of silver are blended with a polymer that is melted and blown from a nozzle onto a support surface, such as the surface of a rotating drum, in a melt-blowing process. According to another embodiment, a non-woven textile media is coated with a silver-bearing substance. According to a further embodiment, a bi-component sheath-core material is provided, in which the sheath of the fiber is silver-impregnated.

While FIG. 2B shows an inner bag wall 202 with four layers 203 and an outer bag wall 204 with a single layer, other embodiments are contemplated that include other numbers of layers in either or both of the inner and outer bag walls 202, 204, as required to accommodate a selected rate of air flow while providing a selected efficiency in particle removal and a selected antimicrobial capacity. Additionally, embodiments are contemplated in which the positions of the inner and outer bag walls 202, 204 are reversed or mixed, so that a silver impregnated layer is innermost, or is positioned between particle filter layers, with one or more particle filter layers positioned outside of that layer. Furthermore, embodiments are contemplated in which the functions of the inner and outer bag walls 202, 204 are combined, with one or more of the layers 203 of the inner bag wall 202 being impregnated with silver, while the separate silver-impregnated outer bag wall is omitted. With regard to the structure of the vacuum filter bag 132, the material of the inner and/or outer bag walls 202, 204 can be laminated or pressed together, or can be separate from each other, with some amount of space between.

The antimicrobial properties of silver have been known for centuries, although the mechanism by which it operates is still not fully understood. While the use of silver has been largely discontinued with the advent of immunizations, antibiotics, antiseptic cleaners, and the like, many recent and ongoing studies are exploring the benefits of silver, which in some cases still exceed those of more recent-and more expensive-treatments. Silver used in research and treatment is provided in various different forms and compounds, including, for example, silver nitrate, silver sulfadiazine, colloidal silver, and nanoparticles of silver. In each case, it is generally understood that the active antimicrobial agent is ionized silver, and that whatever the form in which it is delivered to the site, the silver releases ions when it comes into contact with moisture. Accordingly, it would not be expected that silver would be effective as an antimicrobial agent while dry. However, recent research has shown that when impregnated with silver, dry, porous materials can exhibit significant antimicrobial properties. For example, a recent study examined the antimicrobial effect of surgical masks coated with nanoparticles of silver nitrate and titanium dioxide. In that study, a 100% reduction in viable E. coli and S. aureus was observed in the coated mask materials after 48 hours of incubation. (Antimicrobial effect of surgical masks coated with nanoparticles (abstract), Li Yet al., The Journal of Hospital Infection, 2006 January; 62(1): 58-63. Epub 2005 Aug. 15.)

It should be noted that in known systems that provide a true HEPA-quality vacuum filter bag, the bag traps most pathogens that are collected. However, this means that after use, the bag itself may be highly contaminated, so that a user who handles the vacuum filter bag risks being infected by pathogens present in or on the surface of the bag, or that are released in high concentration in the air when the bag is removed from the machine or thrown into a garbage receptacle. In embodiments that include an inner layer of silver impregnated material, the silver kills any pathogens that come into contact, significantly reducing the danger of infection to those who handle the bag or come into contact with the contents.

The embodiment shown in FIG. 1 includes a filter assembly 128 through which exhaust air is passed prior to exiting the machine. According to an embodiment, the filter assembly 128 includes a filter element (not shown) that is impregnated with silver, and that serves as a final stage to ensure that the exhaust air is free of live pathogens. Depending upon its selected MERV rating, the filter assembly 128 can also act to remove particulates that pass through the vacuum filter bag. In some embodiments, the filter assembly 128 is provided as an alternative to the silver-impregnated outer bag wall 204; in other embodiments, the filter assembly 128 is provided in addition to the silver-impregnated outer bag wall 204, acting as a backup stage. According to another embodiment, the filter assembly 128 has a MERV rating that is higher than that of the vacuum filter bag 132 and is positioned to further clean the exhaust air.

It will be recognized that, while a manufacturer may recommend a particular schedule or frequency of service and bag replacement, the manufacturer cannot force compliance, and that some users may overfill a vacuum filter bag to a point well beyond its rated capacity, before replacing the bag. In such cases, a vacuum filter bag can degrade, so that it is no longer capable of removing small particles, and its antimicrobial properties may be compromised. In such cases, the addition of silver to the filter assembly 128 can act as insurance, and continue to extend antimicrobial protection and/or to remove very fine particles from the exhaust air.

The inventors have found that manufacturing a vacuum filter bag with silver impregnation, as described above, is relatively inexpensive, particularly when compared to the cost of producing a vacuum filter bag with a true HEPA rating, not to mention the cost of a vacuum cleaner capable of drawing air through such a bag without significant loss of efficiency.

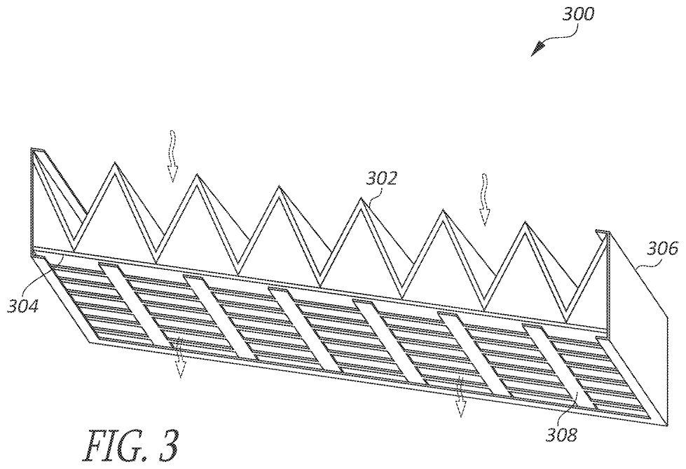

FIG. 3 is a perspective view of an air filter assembly 300, according to an embodiment, with one side removed to show internal elements. The filter assembly 300 can be configured for use with an environmental air cleaning system, such as, e.g., HVAC system, a residential or commercial air cleaner, a vehicle air cleaning system, a vacuum cleaner output filter like the filter assembly 128 described above, etc. The air filter assembly 300 includes a first filter element 302 with a selected MERV rating and capacity. A second filter element 304 is also provided, which is impregnated with silver or a silver compound and is configured to exert an antimicrobial action on air as it passes through the filter assembly 300. Side walls form a frame 306 that surround the filter assembly 300 on four sides, and is configured according to a particular intended use. For example, most systems that are configured to provide filtered air require specific unique filters, which must be replaced periodically to maintain efficiency.

During operation, air pressure against the filter element 302, as air passes through the assembly, can tend to push the filter and antimicrobial elements 302, 304 outward from the frame 306. Accordingly, a support grid 308 is attached to the frame 306 on the output side of the filter assembly 300 to provide physical support to the filter and antimicrobial elements 302, 304. The filter element 302 has an accordion shape, which provides increased surface area, thereby increasing the capacity and reducing air resistance of the assembly.

In the embodiment shown in FIG. 3, the first filter element 302 is shown as being positioned inward with respect to the second filter element 304. The terms inner and outer, and related terms are used, with reference to the elements of the filter assembly 300 to describe the relative positions of those elements with respect to the intended direction of air flow, with inward referring to an element that is upstream relative to another element, and outward referring to an element that is downstream, relative to another element. Thus, functionally, the terms correspond in meaning to the use of similar terms in describing elements of the vacuum filter bag 132 of FIGS. 1-2B.

A number of alternative embodiments are contemplated with respect to the filter assembly 300, generally corresponding to the various alternative embodiments described above with reference to the vacuum filter bag 132, and in particular to those described with reference to FIG. 2B. For example, the first filter element 302 corresponds generally to the inner bag wall 202, and can include one or a plurality of layers of material, each having a respective efficiency, which together provide a collective efficiency. Similarly, the second filter element 304 corresponds generally to the outer bag wall 204, and can also include one or multiple layers, and can also be combined with or incorporated into the first filter element, substantially as described above with reference to the inner and outer bag walls 202, 204 of FIGS. 2A and 2B.

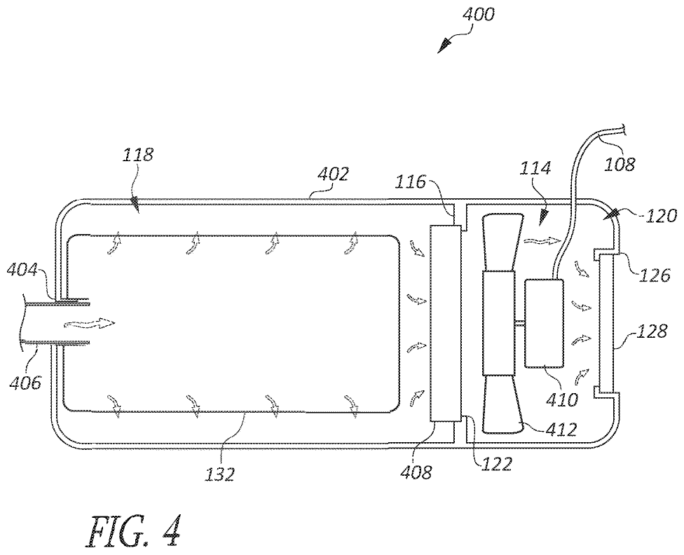

In addition to the upright vacuum cleaner 100 described above with reference to FIG. 1, other embodiments are contemplated, in which various other types of vacuum cleaners are provided. For example, FIG. 4 is a diagrammatic representation of a canister vacuum 400, according to an embodiment. The canister vacuum 400 includes a casing 402 that houses other elements on the device. An input aperture 404 is configured to receive a vacuum hose 406 through which air is drawn during operation. In addition to various elements of the vacuum 400 that correspond functionally with similar elements described with reference to the vacuum cleaner 100 of FIG. 1, and which are indicated by the same reference numbers, elements of the motor assembly 114 are shown in more detail, including the motor 410 operatively coupled to the blower 412. In addition to an output filter assembly 128, the vacuum 400 includes a pre-motor filter assembly 408 configured to filter air exiting the vacuum chamber 118 before passing through the blower and exiting the machine. The output filter assembly 128 and the pre-motor filter assembly 408 can each be configured according to the particular requirements of the device, and can be configured as described with reference to the filter 300 of FIG. 3, can be configured as only particulate or antimicrobial filters, or can be configured according to other requirements.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

What is claimed is:

1. A vacuum filter bag for a vacuum cleaner comprising:
an interior of the vacuum filter bag configured to receive a flow of exhaust air from a waste intake channel of the vacuum cleaner that passes through a filter assembly prior to exiting the vacuum cleaner, wherein the filter assembly includes a filter element that has a Minimum Efficiency Reporting Value (“MERV”) rating that is higher than that of the vacuum filter bag and the filter element is impregnated with silver to ensure that the flow of exhaust air is free of live pathogens;
a permeable bag wall configured for passage of the flow of exhaust air therethrough, from an inner bag wall of the vacuum filter bag to an outer bag wall of the vacuum filter bag, the permeable bag wall further comprising:
a plurality of layers of material, each of the plurality of layers of material having a MERV rating; and
at least one of the plurality of layers of material is a silver-impregnated material that is a micro and/or nanoparticles of silver blended with a polymer that is melted and blown from a nozzle onto a support surface in a melt-blowing process;
wherein each of the plurality of layers of material have a respective degree of efficiency, and each of the plurality of layers of material contribute to a collective efficiency.

2. The vacuum filter bag for a vacuum cleaner according to claim 1 wherein the plurality of layers of material further comprises:
an inner layer of material disposed towards the inner bag wall configured to capture a first level of particles;
at least one second layer of material disposed between the inner bag wall and the outer bag wall configured to capture a second level of particles finer than the first level of particles; and
an outer layer of material disposed towards the outer bag wall configured to capture a third level of particles finer than the second level of particles.

3. The vacuum filter bag for a vacuum cleaner according to claim 1 further comprising:
a MERV rating of the outer bag wall that is lower than a MERV rating of the inner bag wall to allow the flow of exhaust air to pass through the vacuum filter bag.

4. The vacuum filter bag for a vacuum cleaner according to claim 1 further comprising:
a MERV rating of the layer of material that is the silver-impregnated material is higher than the MERV rating of the plurality of layers of materials that are not silver-impregnated material.

5. The vacuum filter bag for a vacuum cleaner according to claim 1 wherein the plurality of layers of material further comprises:
an inner layer of silver-impregnated non-woven filter material according to the melt-blowing process of claim 1 and is disposed towards the inner bag wall of the vacuum filter bag and having a first MERV rating;

6. an outer layer of non-woven filter material disposed towards the outer bag wall of the vacuum filter bag and having a second MERV rating; and
a layer of non-woven filter material disposed intermediate of the inner bag wall and the outer bag wall of the vacuum filter bag and having a third MERV rating.

6. The vacuum filter bag for a vacuum cleaner according to claim 1 wherein the plurality of layers of material further comprises:
an inner layer of non-woven filter material according to the melt-blowing process of claim 1 and is disposed towards the inner bag wall of the vacuum filter bag and having a first MERV rating;
an outer layer of non-woven filter material disposed towards the outer bag wall of the vacuum filter bag and having a second MERV rating; and
a layer of silver-impregnated non-woven filter material disposed intermediate of the inner bag wall and the outer bag wall of the vacuum filter bag and having a third MERV rating.

7. The vacuum filter bag for a vacuum cleaner according to claim 1 wherein the plurality of layers of material further comprises:
an inner layer of non-woven filter material according to the melt-blowing process of claim 1 and is disposed towards the inner bag wall of the vacuum filter bag and having a first MERV rating;
an outer layer of silver-impregnated non-woven filter material disposed towards the outer bag wall of the vacuum filter bag and having a second MERV rating; and
a layer of non-woven filter material disposed intermediate of the inner bag wall and the outer bag wall of the vacuum filter bag and having a third MERV rating.

8. The vacuum filter bag for a vacuum cleaner according to claim 1 wherein the plurality of layers of material are laminated to each other.

9. The vacuum filter bag for a vacuum cleaner according to claim 1 wherein the plurality of layers of material are separate from each other with an amount of space between.

10. The vacuum filter bag for a vacuum cleaner according to claim 1 wherein a material the inner bag wall and the outer bag wall is selected from the group consisting of:
a melt-blown non-woven filter material;
a spun fiberglass material;
a woven fabric material; and
a porous paper.

11. The vacuum filter bag for a vacuum cleaner according to claim 1 wherein the silver impregnated material is the micro and/or nanoparticles of silver and is selected from the group consisting of:
a silver-bearing compound;
a silver-bearing substance;
an ions of silver;
a silver nitrate;
a silver sulfadiazine;
a colloidal silver; and
a nanoparticles of silver.

12. The vacuum filter bag for a vacuum cleaner according to claim 1 further comprising:
a MERV rating of the silver-impregnated material is no more than about 9; and
a combined MERV rating of all of the plurality of layers of material is about 13.

13. A vacuum filter bag for a vacuum cleaner comprising:
an interior of the vacuum filter bag configured to receive a flow of exhaust air from a waste intake channel of the vacuum cleaner that passes through a filter assembly prior to exiting the vacuum cleaner, wherein the filter assembly includes a filter element that has a Minimum Efficiency Reporting Value (“MERV”) rating that is higher than that of the vacuum filter bag and the filter element is impregnated with silver to ensure that the flow of exhaust air is free of live pathogens;
a permeable bag wall configured for passage of the flow of exhaust air therethrough, from an inner bag wall of the vacuum filter bag to an outer bag wall of the vacuum filter bag, the permeable bag wall further comprising:
a plurality of layers of material, each of the plurality of layers of material having a Minimum Efficiency Reporting Value (“MERV”) rating; and
at least one of the plurality of layers of material is a silver-impregnated material that is a bi-component sheath-core material in which a sheath of the bi-component sheath-core material is silver impregnated;
wherein each of the plurality of layers of material have a respective degree of efficiency, and each of the plurality of layers of material contribute to a collective efficiency.
